(19) United States
(12) Patent Application Publication
(10) Pub. No.: US 2024/0026801 A1
(43) Pub. Date: Jan. 25, 2024

(54) ROTOR COOLING SYSTEM FOR SHUTDOWN

(71) Applicant: GENERAL ELECTRIC COMPANY, Schenectady, NY (US)

(72) Inventors: Mithunraj KK, Greenville, SC (US); Chennoju VEERRAJU, Bangaluru (IN); Eric D. ROUSH, Greenville, SC (US)

(21) Appl. No.: 17/814,266

(22) Filed: Jul. 22, 2022

(51) Int. Cl. F01D 25/12

(52) U.S. Cl. CPC F01D 25/12; F05D 2220/32; F05D 2260/232

(57) ABSTRACT

The present application provides a rotor cooling system for cooling a rotor of a gas turbine engine during shutdown operations. The rotor cooling system may include an external blower, piping that extends from the external blower to the rotor, and a valve on the piping that opens when shutdown operations begin so as to send cooling air from the external blower to the rotor.

### TECHNICAL FIELD

The present application and the resultant patent relate generally to gas

turbine engines and more particularly relate to a rotor cooling system for shutdown operations to control turbine blade clearances to enable a hot restart without blade tip rubbing.

### BACKGROUND

A gas turbine engine conventionally includes a compressor for compressing ambient air and a combustor for mixing the air with fuel to generate hot combustion gases. A turbine receives the hot combustion gases and extracts energy therefrom for powering the compressor and producing output power such as for an electrical generator. The turbine conventionally includes one or more stages of stator nozzles, rotor blades, and annular shrouds around the components for maintaining appropriate clearances therewith. As the turbine inlet temperatures have increased to improve the overall efficiency of the gas turbine engine, a cooling fluid, such as air, may be required to maintain the temperatures of the turbine nozzles, blades, and shrouds at levels that can be withstood by the materials thereof. Cooling is typically accomplished by extracting a portion of the air from the compressor and conducting it to the hot gas path components of the turbine. Any air compressed in the compressor and not used in generating combustion gases necessarily reduces the overall efficiency of the gas turbine engine. Therefore, it is desirable to minimize the amount of cooling air bled from the compressor.

Gas turbine efficiency and reliability are impacted by the clearances maintained between the rotating and the static hardware. Tighter clearances produce higher efficiencies, but also increase the likelihood of damage from rubbing (e.g., during hot restarts). During shutdown, the casing of the gas turbine engine generally cools off faster than the rotor due to their different geometries. During a warm or hot restart, the thermal mismatch between the casing and the rotor may cause the rotor to have a greater initial component of thermal growth. This causes a transient clearance pinch point between the rotor blades and the casing. As time progresses, the casing thermally expands away from the rotor and results in more open full speed, full load clearances. The build clearances of a unit must be set in such a way as to avoid rubbing during the transient pinch point and to remain tight at full speed, full load. The difference in minimum clearance to full speed, full load clearance may be defined as “entitlement.” The entitlement is determined by the thermal mismatch between rotor and casing.

Because the efficiency of a gas turbine engine is dependent in part on the operating temperatures, there is an ongoing demand for components positioned along and within the hot gas path to be capable of withstanding increasingly higher temperatures without deterioration, failure, or a decrease in the overall useful lifetime. Cooling such components in a manner that does not negatively impact the gas turbine efficiency would represent a useful advancement in the art.

### SUMMARY

The present application and the resultant patent provide a rotor cooling system for cooling a rotor of a gas turbine engine during shutdown operations. The rotor cooling system may include an external blower, piping that extends from the external blower to the rotor, and a valve on the piping that opens when shutdown operations begin to send cooling air from the external blower to the rotor.

The present application and the resultant patent further provide a method of cooling a rotor of a gas turbine engine during shutdown operations. The method may include the steps of initiating shutdown operations of the gas turbine engine, opening a valve on piping that extends from an external blower to the rotor, providing cooling air from the external blower to the rotor via the piping, and cooling the rotor to minimize a thermal mismatch between the rotor and an outer casing of the gas turbine engine.

The present application and the resultant patent further provide a gas turbine engine. The gas turbine engine includes a turbine, a rotor that extends through the turbine, and a rotor cooling system for cooling the rotor during shutdown operations of the gas turbine engine. The rotor cooling system may include an external blower, piping that extends from the external blower to the rotor, and a valve on the piping that opens when shutdown operations begin so as to send cooling air from the external blower to the rotor.

These and other features and improvements of this application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine including a compressor, a combustor, a turbine, an exhaust frame, and an external load.

FIG. 2 is a partial sectional view of the turbine of FIG. 1 showing the turbine nozzles, blades, and wheels.

FIG. 3 is a cross-sectional view of the compressor or the turbine of FIG. 1 showing an outer casing, an inner shroud, a number of blades, and the rotor.

FIG. 4 is a schematic view of a rotor cooling system as described herein for use with the gas turbine engine of FIG. 1.

### DETAILED DESCRIPTION

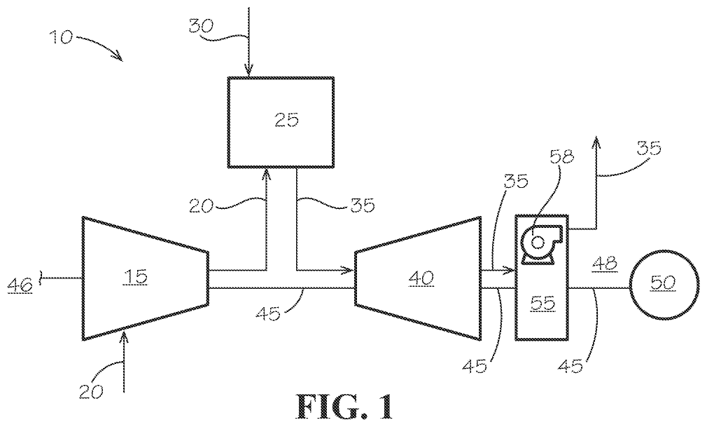

Referring now to the drawings, in which like numerals refer to like elements throughout the several views, FIG. 1 shows a schematic diagram of gas turbine engine 10 as may be used herein. The gas turbine engine 10 may include a compressor 15. The compressor 15 compresses an incoming flow of air 20. The compressor 15 delivers the compressed flow of air 20 to a number of combustor cans 25. The combustor cans 25 mix the compressed flow of air 20 with a pressurized flow of fuel 30 and ignite the mixture to create a flow of hot combustion gases 35. Although only a single combustor can 25 is shown, the gas turbine engine 10 may include any number of combustor cans 25 positioned in a circumferential array and the like. Alternatively, the combustor 25 may be an annular combustor. The flow of combustion gases 35 is in turn delivered to a turbine 40. The flow of combustion gases 35 drives the turbine 40 so as to produce mechanical work. The mechanical work produced in the turbine 40 drives the compressor 15 via a rotor shaft 45 and an external load 50 such as an electrical generator and the like.

The flow of combustion gases 35 is delivered from the turbine 40 to an exhaust frame 55 positioned downstream thereof. The exhaust frame 55 may contain and direct the flow of combustion gases 35 to other components of the gas turbine engine 10. An exhaust frame blower 58 and the like may be used. For example, the exhaust frame may direct the flow of combustion gases 35 to an exhaust plenum or an exhaust diffuser. Other types of external blowers also may be used. Other configurations and other components may be used herein.

The gas turbine engine 10 may use natural gas, various types of syngas, liquid fuels, and/or other types of fuels and blends thereof. The gas turbine engine 10 may be any one of a number of different gas turbine engines offered by General Electric Company of Schenectady, New York, including, but not limited to, those such as a 7-series or a 9-series heavy duty gas turbine engine and the like and may be part of a simple cycle or a combined cycle power generation system. The gas turbine engine 10 may have different configurations and may use other types of components. Other types of gas turbine engines also may be used herein. Multiple gas turbine engines, other types of turbines, and other types of power generation equipment also may be used herein together.

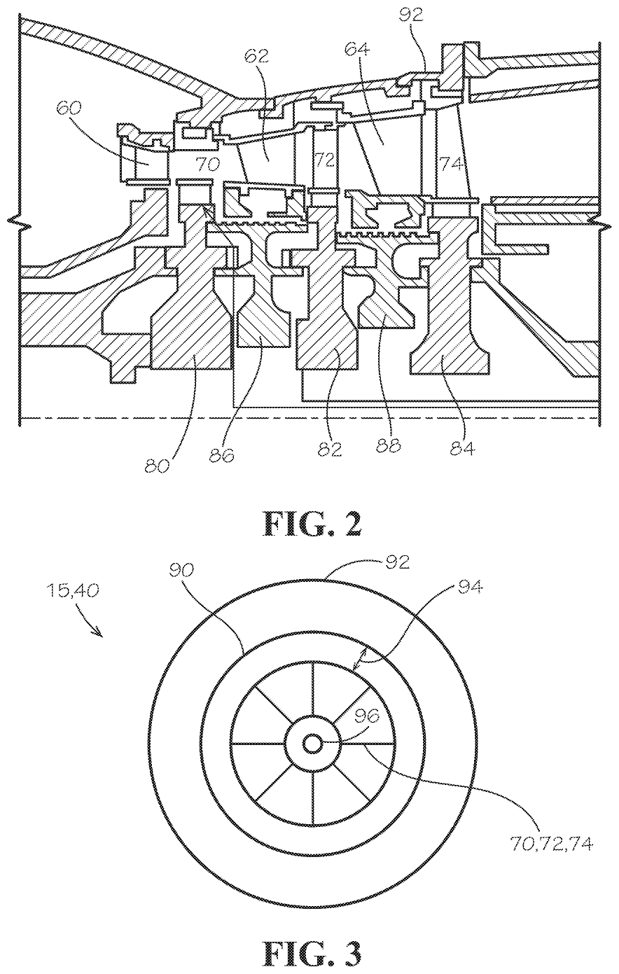

As is shown in FIGS. 2 and 3, the turbine 40 includes a number of stator nozzles 60, 62, 64 and a number of rotating blades 70, 72, 74 arranged in stages. For example, a first stage includes the stator nozzle 60, a second stage includes the stator nozzle 62, and a third stage includes the stator nozzle 64. In the blade section, blades 70, 72, 74 are connected to rotor wheels 80, 82, 84, respectively, of the rotor 45. The wheel and the blade 70 form the first stage, the wheel 82 and the blade 72 form the second stage, and the wheel 84 and the blade 74 form the third stage. Spacers 86, 88 may be provided between each pair of rotor wheels. In some embodiments, the turbine 40 may include four stages of stationary nozzles and rotating blades. Within the turbine 40, a portion of the kinetic energy is transferred to blades 70, 72, 74 and is converted to mechanical work.

The blades 70, 72, 74 rotate within an inner shroud 90 which is concentric within and supported by an outer casing 92. A blade tip clearance 94 is desired between the tips of the blades 70, 72, 74 and the inner shroud 90. This clearance is exaggerated in FIG. 3 for the purpose of illustration. As will be described in more detail below, the rotor may have one or more rotor bore cavities 96 therein for receiving a cooling medium and the like.

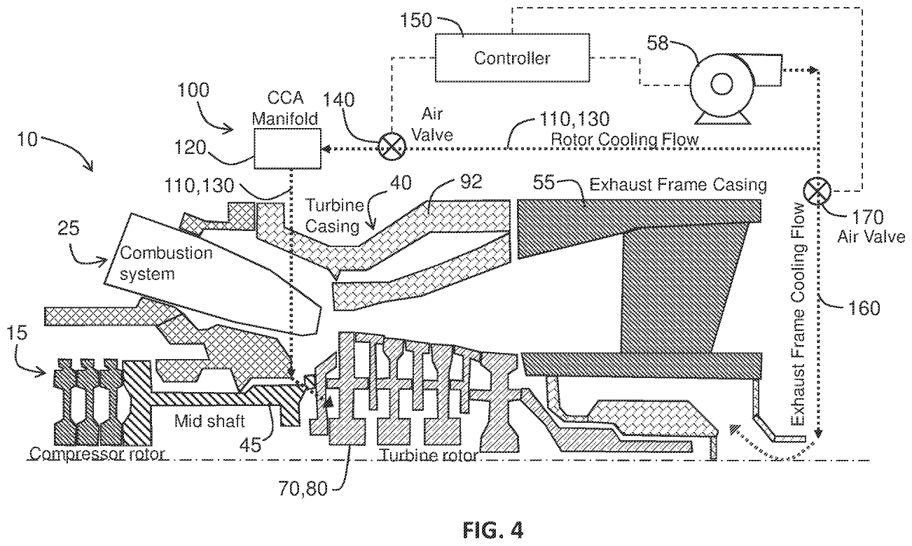

As is shown in FIG. 4, the gas turbine engine 10 may be used with a rotor cooling system 100. For simplicity, the stator nozzles and rotor blades of the compressor and the turbine 40 are omitted.

Specifically, the rotor cooling system 100 may deliver a flow of cooling air 110 to the rotor bore cavities 96 of the rotor 45 during shutdown operations. The rotor cooling system 100 may use an existing cooled cooling air manifold 120 if available. The cooled cooling air manifold 120 conventionally brings an extraction of air 20 from the compressor 15 to the hot gas path components. In this case, the rotor cooling system 100 may include piping 130 that fluidly connects the cooled cooling air manifold 120 to the exhaust frame blower 58 or other type of external blower (as opposed to a compressor extraction) to deliver a flow of cooling air 110 from the exhaust frame blower 58 through the outer casing 92 and into the rotor bore cavities 96. The rotor cooling system 100 may have a valve 140 (e.g., an on/off valve) on the piping 130 that is open only during shutdown. The valve 140 may be in communication with a controller 150, which may be part of the overall control system of the gas turbine engine 10. During operation of the gas turbine engine 10 as well as during shutdown, the exhaust frame blower 58 supplies exhaust frame cooling flow 160 to the exhaust frame casing 55 via a valve 170. The controller 150 communicates with the valve 170. Other components and other configurations may be used herein.

Specifically, the rotor cooling system 100 may be activated by the controller 150 upon detection of flame out or other parameters that indicate overall shutdown of the gas turbine engine 10. The rotor cooling system 100 may be operational based upon elapsed time (e.g., with valve 140 remaining open for a predetermined amount of time after shutdown operations begin), determined temperature (e.g., with the valve 140 remaining open until the rotor 45 reaches a predetermined temperature after shutdown operations begin), or upon gas turbine engine restart (e.g., with the valve 140 remaining open after shutdown operations begin until restart of the gas turbine engine The rotor cooling system 100 thus improves stage one turbine blade tip clearance by reducing the pinch closure upon a hot restart. This is achieved by minimizing the thermal mismatch of the rotor 45 and the casing 92 during shutdown through increased cooling of the rotor 45. The rotor cooling system 100 utilizes the existing flow 140 from the exhaust frame blower 58 during shutdown and directs the cooling air into the rotor bore cavities 96. This rotor cooling system 100 will not be active during normal full speed operation (e.g., the valve 140 will remain closed during full speed operation) but will be turned on only during shutdown so as to feed the cooling air 110 for the stage one wheel to reduce the rotor temperature prior to the next hot restart. This will improve the stage one blade tip clearance.

The stage one turbine blade tip running clearance at steady state is a significant contributor to overall gas turbine performance. The ability to set tighter running clearance is limited mostly by the thermal time constant mismatch between the rotor 45 and the casing 92. Turbine blades typically have a pinch point on a hot start, which is mainly driven by the hot rotor 45 that retains heat and does not cool off as fast as the casing 92 during shutdown. For instance, as the casing 92 cools more rapidly than the rotor 45 and contracts, there is a risk of blade tip rubbing on the inner shroud 90, which can result in blade damage. In existing gas turbine engines without a rotor cooling system 100, the higher pinch closure on hot restart dictates the assembly clearance that causes the turbine blade tip to run with an open clearance at steady state, thereby reducing turbine efficiency.

In the present gas turbine engine 10, the rotor cooling system 100 reduces, during shutdown, the thermal time constant mismatch between the casing 92 and the rotor 45 by feeding the external cooling flow 110 into the rotor bore cavity 96 through external means. This cooling flow will help reduce the pinch closure on subsequent hot restart and provide the ability to set tighter blade tip clearance to improve overall gas turbine performance. The rotor cooling system 100 thus may provide about a fifty-degree Fahrenheit (about ten-degree Celsius) temperature benefit or about a 10 mils clearance benefit or more. In addition, because the flow 110 is produced from the exhaust blower 58 rather than an extraction from the compressor 15, the mass flow through the compressor 15 is maintained, and the gas turbine efficiency does not experience an otherwise parasitic loss of flow for cooling the rotor 45.

It should be apparent that the foregoing relates only to certain embodiments of this application and resultant patent. Numerous changes and modifications may be made herein by one of ordinary skill in the art without departing from the general spirit and scope of the invention as defined by the following claims and the equivalents thereof.

We claim:

1. A rotor cooling system for cooling a rotor of a gas turbine engine during shutdown operations, the rotor cooling system comprising:
an external blower;
piping that extends from the external blower to the rotor; and
a valve on the piping that opens when shutdown operations begin so as to send cooling air from the external blower to the rotor.

2. The rotor cooling system of claim 1, wherein the rotor comprises one or more rotor bore cavities in communication with the piping.

3. The rotor cooling system of claim 1, wherein the rotor comprises a stage one wheel in communication with the piping.

4. The rotor cooling system of claim 3, further comprising a stage one blade connected to the stage one wheel.

5. The rotor cooling system of claim 1, wherein the piping comprises part of a cooled cooling air manifold.

6. The rotor cooling system of claim 1, wherein the piping extends through an outer casing surrounding at least a portion of the gas turbine engine.

7. The rotor cooling system of claim 1, wherein the valve comprises an on/off valve.

8. The rotor cooling system of claim 1, wherein the valve remains open for a predetermined amount of time after shutdown operations begin.

9. The rotor cooling system of claim 1, wherein the valve remains open until the rotor reaches a predetermined temperature after shutdown operations begin.

10. The rotor cooling system of claim 1, wherein the valve remains open after shutdown operations begin until gas turbine engine restart.

11. The rotor cooling system of claim 1, wherein the rotor cooling system provides about a fifty-degree Fahrenheit (about ten-degree Celsius) temperature reduction to the rotor.

12. The rotor cooling system of claim 1, wherein the rotor cooling system provides about a 10 mils clearance reduction to the rotor.

13. The rotor cooling system of claim 1, wherein the valve is closed during full speed operations.

14. The rotor cooling system of claim 1, wherein the external blower comprises an exhaust frame blower.

15. A method of cooling a rotor of a gas turbine engine during shutdown operations, comprising:
initiating shutdown operations of the gas turbine engine;
opening a valve on piping that extends from an external blower to the rotor;
providing cooling air from the external blower to the rotor via the piping; and
cooling the rotor to minimize a thermal mismatch between the rotor and an outer casing of the gas turbine engine.

16. A gas turbine engine, comprising:
a turbine;
a rotor that extends through the turbine; and
a rotor cooling system for cooling the rotor during shutdown operations of the gas turbine engine;
wherein the rotor cooling system comprises an external blower, piping that extends from the external blower to the rotor, and a valve on the piping that opens when shutdown operations begin so as to send cooling air from the external blower to the rotor.

17. The gas turbine engine of claim 16, wherein the rotor comprises one or more rotor bore cavities in fluid communication with the piping.

18. The gas turbine engine of claim 16, wherein the rotor comprises a stage one wheel in fluid communication with the piping.

19. The gas turbine engine of claim 16, wherein the piping comprises part of a cooled cooling air manifold.

20. The gas turbine engine of claim 16, wherein the external blower comprises an exhaust frame blower.
